(19) United States
(12) Patent Application Publication
(10) Pub. No.: US 2016/0325418 A1
(43) Pub. Date: Nov. 10, 2016

(54) Method and Apparatus for the Removal of a Lodged Object From a Receptacle

(71) Applicant: Artronika IP LLC, Orlando, FL (US)

(72) Inventors: Eugenio Diaz, Orlando, FL (US); Shane A. Reynolds, Orlando, FL (US)

(21) Appl. No.: 15/147,343

(22) Filed: May 5, 2016

Related U.S. Application Data
(60) Provisional application No. 62/156,907, filed on May 5, 2015.

(51) Int. Cl. B25B 27/02

(52) U.S. Cl. CPC B25B 27/02

(57) ABSTRACT

A tool assembly (6) is provided for removing a lodged object (7) from a cavity (8). The tool assembly includes a tool (3) with a hollow interior volume (13) defined by a first radius (11) and an outer surface (17) defined by a second radius (15) that is greater than the first radius (11). The outer surface of the tool is configured to be compressed upon insertion of the tool within the cavity. The first radius (11) is sized such that the hollow interior volume (13) is configured to receive the lodged object (7) upon insertion of the tool between the lodged object and the internal walls of the cavity and to frictionally engage the lodged object such that the object may be removed by withdrawing the tool (3) from the cavity (8). A method (100) is also provided for removing the lodged object (7) from the cavity (8).

### CROSS-REFERENCE TO RELATED APPLICATIONS

This application claims benefit of Provisional Application No. 62/156,907 filed May 5, 2015, the entire contents of which are incorporated by reference as if fully set forth herein, under 35 U.S.C. §119(e).

### BACKGROUND

A problem often encountered when using headphones with electronic devices; especially mobile ones, like phones, notebooks, and tablets, is that the headphone plug could get broken, leaving a small piece inside the device. This happens because the stud part of the headphone plug has several plastic rings that separate the different contacts; and it is along those rings that the plug is structurally weak.

When this happens, the piece that remains stuck inside the device's headphone receptacle is enough to trigger the headphone detection feature of the device, in turn disabling the device's internal speakers. Since most devices do not have an “override” setting for this detection, it leaves the device unable to play audio, which is one of the primary functions of such devices.

Due to the size and shape of the broken headphone plug piece, the location where it is lodged deep inside the receptacle, and the pressure from the receptacle's latching contacts, it is extremely difficult to remove. Many removal methods fail to yield positive results, and instead carry the risk of damaging the device further. Drilling may cause irreparable damage to the receptacle. Professional repair services are very costly, as it often requires a skilled technician to disassemble delicate and tightly integrated components in order to replace the entire receptacle assembly.

### BRIEF SUMMARY

In one example embodiment, a tool assembly is provided for removing a lodged object from a cavity. The tool assembly includes a tool with a hollow interior volume defined by a first radius and an outer surface defined by a second radius, where the second radius is greater than the first radius. The outer surface of the tool is configured to be compressed upon insertion of the tool within the cavity. The first radius is sized such that the hollow interior volume is configured to receive the lodged object upon insertion of the tool between the lodged object and the internal of the cavity and to frictionally engage the lodged object such that the object may be removed by withdrawing the tool from the cavity.

In another example embodiment, a method is provided for removing a lodged object from a cavity. The method includes inserting a tool between the lodged object and internal walls of the cavity. The method also includes frictionally engaging the lodged object within an inner surface of the tool. The method also includes simultaneously extracting the tool and the lodged object from the cavity.

In another example embodiment, a tool assembly is provided for removing a lodged object from a cavity. The tool assembly includes a tool with an inner surface made of a first material, where the inner surface is configured to engage the lodged object with a first frictional force. The tool also includes an outer surface made of a second material, where the outer surface is configured to engage internal walls of the cavity with a second frictional force. The first material and the second material are selected such that the first frictional force is greater than the second frictional force and such that the object is removed by withdrawing the tool from the cavity. The tool is a strip that extends over a portion of the perimeter of the lodged object such that the strip does not encompass the lodged object within the cavity. The first material is selected such that the first frictional force during removal of the tool from the cavity is greater than during insertion of the tool within the cavity.

### BRIEF DESCRIPTION OF THE DRAWINGS

FIG. 1A shows a perspective view of one example of the headphone plug removal tool assembly with an expanded detail of the tip of the tool, according to one embodiment of the present invention.

FIG. 1B shows a cross-sectional view of one example of the cylinder of the tool assembly of FIG. 1A in an uncompressed position, according to one embodiment of the present invention.

FIG. 1C shows a cross-sectional view of one example of the cylinder of the tool assembly of FIG. 1A in a compressed position, according to one embodiment of the present invention.

FIG. 2 shows a perspective view of one example of a tool shown in relation to a broken headphone plug piece and the headphone receptacle in a mobile device, according to one embodiment of the present invention.

FIG. 3 shows a perspective cutaway view of one example of internals of the mobile device of FIG. 2, including the broken headphone plug piece lodged inside the device's headphone receptacle, according to one embodiment of the present invention.

FIG. 4 shows a perspective cutaway view of one example of internals of the mobile device of FIG. 2, including the tool physically isolating the broken headphone piece from the device's headphone receptacle, according to one embodiment of the present invention.

FIG. 5 shows a perspective view of one example of the tool and mobile device after the removal process, where the broken headphone piece is now inside of the tool, according to one embodiment of the present invention.

FIG. 6 shows a perspective view of one example of the tool and mobile device in FIG. 5, but with an expanded cutaway detail of the internals of the tool, showing the removed broken headphone piece inside the tool, according to one embodiment of the present invention.

FIG. 7 shows a flowchart of one example of a method for removing a broken headphone plug piece from a headphone receptacle of a mobile device, according to one embodiment of the present invention.

FIGS. 8A-8B show perspective and cross-sectional views of one example of the cylinder of the tool assembly of FIG. 1A, according to one embodiment of the present invention.

FIG. 9 shows a perspective view of one example of the cylinder of the tool assembly of FIG. 1A, according to one embodiment of the present invention.

FIG. 10 shows a perspective view of one example of the cylinder of the tool assembly of FIG. 1A, according to one embodiment of the present invention.

FIGS. 11A-11C show perspective views of one example of the cylinder of the tool assembly of FIG. 1A, according to one embodiment of the present invention.

FIG. 12 shows a perspective view of one example of a tool of a removal tool assembly for a headphone plug, according to one embodiment of the present invention.

FIGS. 13A-13C show perspective views of one example of the tool of the tool assembly of FIG. 12, according to one embodiment of the present invention.

FIGS. 14A-14D show perspective views of one example of the tool of the tool assembly of FIG. 1A, according to one embodiment of the present invention.

FIGS. 15A-15B show perspective views of one example of pliers being used to extract the tool from the headphone receptacle, according to one embodiment of the present invention.

FIGS. 16A-16B show perspective views of one example of fingers being used to extract the tool from the headphone receptacle, according to one embodiment of the present invention.

### DETAILED DESCRIPTION

In an example embodiment, a tool is provided that would extract a lodged object from a cavity or receptacle with internal walls. In the example embodiment, the lodged object is a broken plug piece and the tool removes the plug piece from a receptacle without damaging the receptacle. In an example embodiment, the tool consists of a hollow cylinder that is inserted in between the receptacle wall, and the broken plug piece. Once the broken plug piece is surrounded by the tool, it can be pulled out along with the tool, since it is physically isolated from the receptacle walls and contact latches.

In another example embodiment, the cylinder is split with a slot along its main axis to allow for receptacle diameter variance and/or to exert pressure on the plug piece as the tool cylinder is compressed by the receptacle walls.

The disclosed embodiments of the invention are directed to the concept of physical isolation. That is, the physical isolation of an object lodged inside of a cavity or enclosure. This isolation is accomplished by the insertion of a tool in between the lodged object and the cavity or enclosure. The insertion of the tool physically isolates the lodged object from any direct contact with the cavity's walls. As there is no physical contact between the lodged object and the cavity's wall, it is thus free to be extracted along with the tool as the tool is pulled out of the cavity. One example embodiment of the invention is a tool for the removal of a broken headphone plug piece from a headphone receptacle.

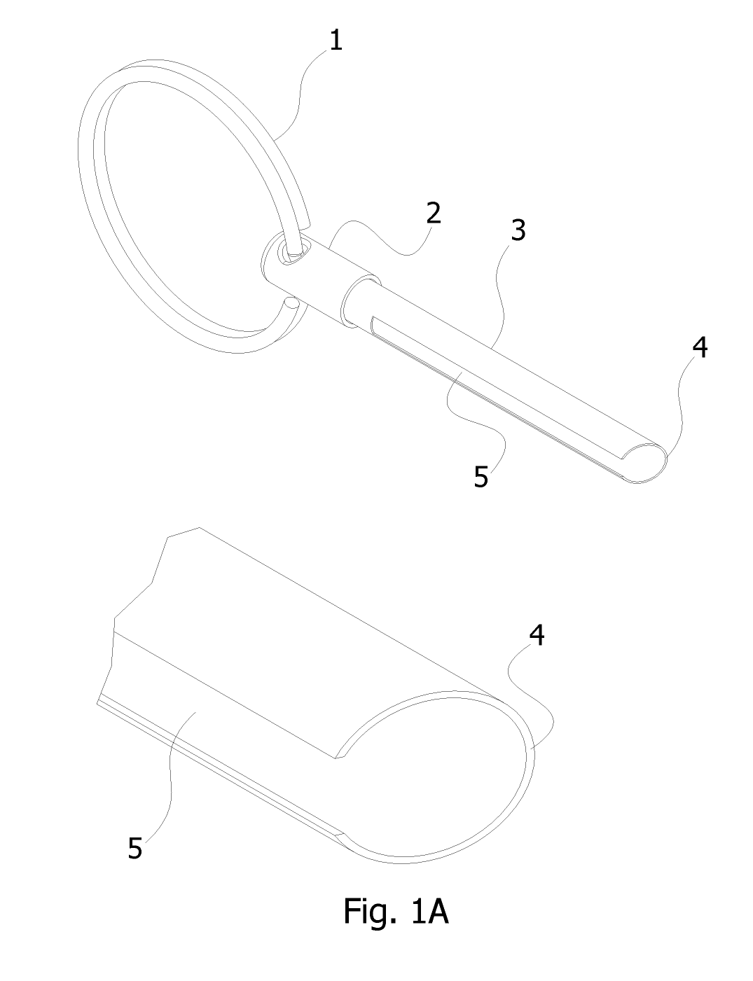

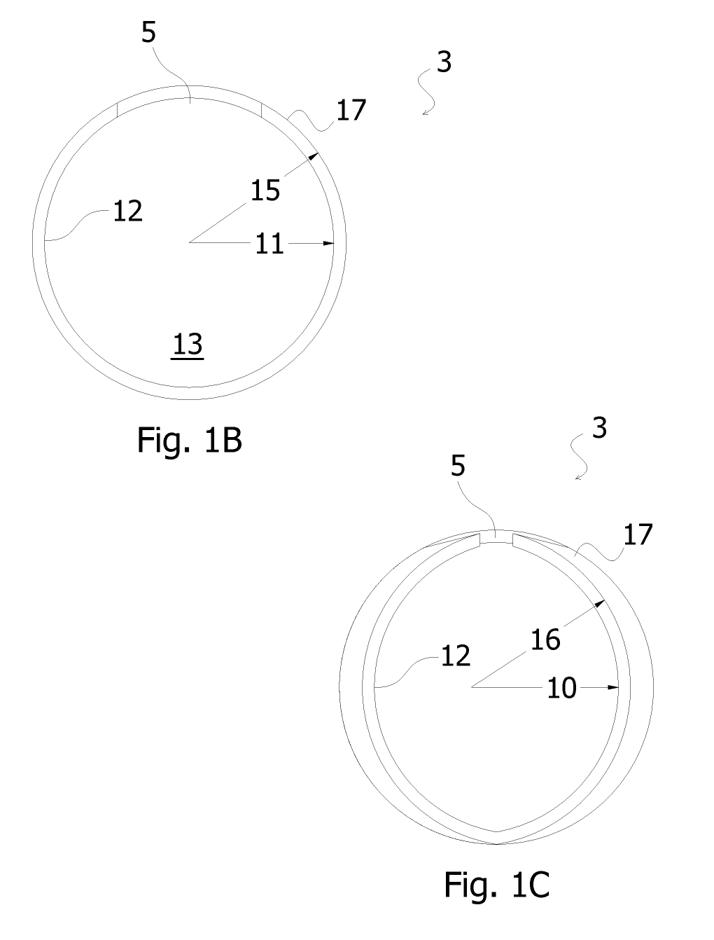

In an example embodiment of the invention illustrated in FIG. 1A, the tool assembly 6 comprises of a thin walled cylinder 3, end cap 2, and split ring 1. Cylinder 3 comprises feature 4, an angle-cut cylinder tip, and feature 5, a slot parallel to the cylinder axis; each of which are an advantage of the example embodiment of the invention. However, the slot 5 need not be oriented parallel to a longitudinal axis of the cylinder 3. FIG. 10 shows another example embodiment of a cylinder 3″ where the slot 5″ is oriented at an angle with respect to the longitudinal axis of the cylinder 3″. In an example embodiment, the angle is 65 degrees or within a range of 40-80 degrees. However, the angle is not limited to any specific value or range. In another example embodiment, the slot 5″ is oriented parallel to the longitudinal axis of the cylinder 3″ at the tip 4 and at a second end 31 of the cylinder 3″ opposite to the tip 4, but the slot 5″ is oriented at the angle relative to the longitudinal axis along a length of the cylinder 3″ between the tip 4 and the second end 31. One advantage of the slot 5″ is a reduction in snags between the cylinder 3″ and electrical contacts along the internal walls of the receptacle 8 during insertion and/or extraction. Another advantage of the slot 5″ is that the cylinder 3″ can be twisted during insertion and/or extraction to assist with the compression of the cylinder 3″ during the insertion or expansion during the extraction.

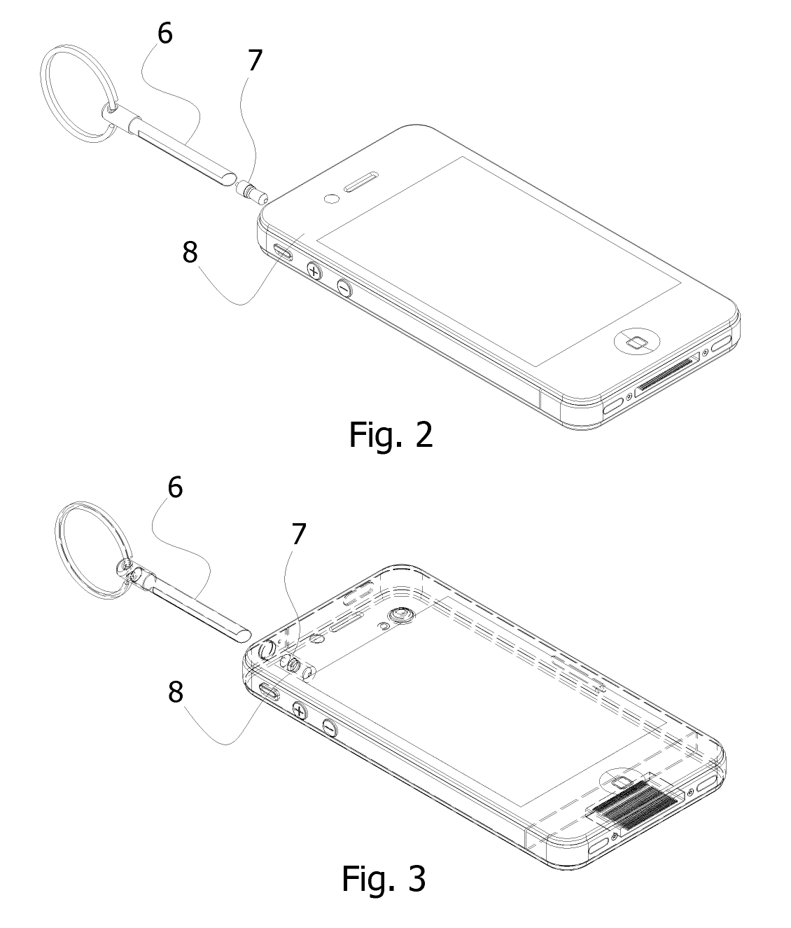

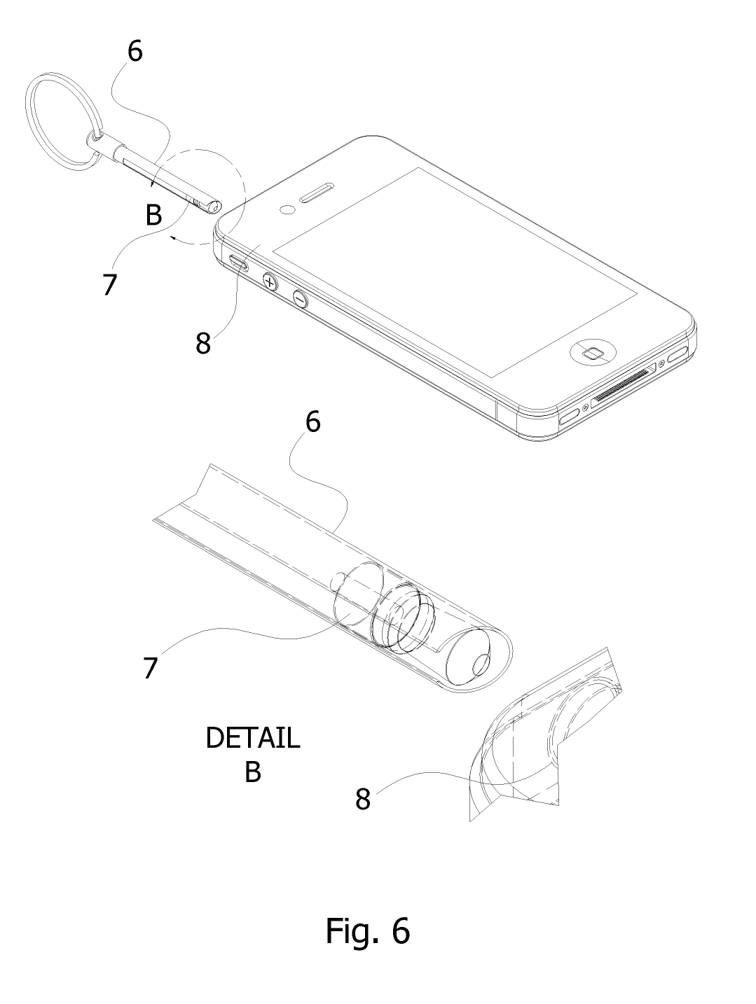

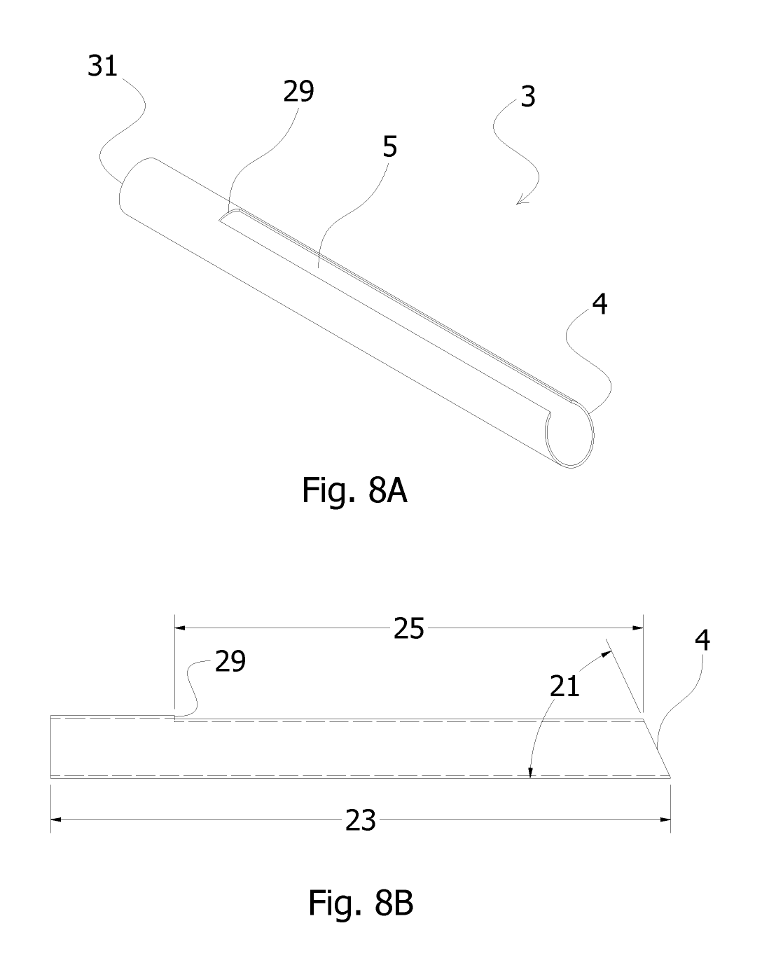

The cylinder 3 need not include feature 4 and feature 5. Feature 4, as best seen in FIG. 1A, improves the insertion of cylinder 3 in between headphone receptacle's 8 internal wall, and broken headphone plug piece 7 as illustrated in FIGS. 2-6. FIGS. 8A-8B shows perspective and cross-sectional views of one example of the cylinder 3. In an example embodiment, the angle-cut cylinder tip 4 forms an angle 21 (FIG. 8B) with the cylinder longitudinal axis, such as 65 degrees or an angle within a range of 50-80 degrees, for example. However, the cylinder 3 need not include the angle-cut tip 4 and instead may feature a square tip that is oriented orthogonal to the cylinder longitudinal axis, for example.

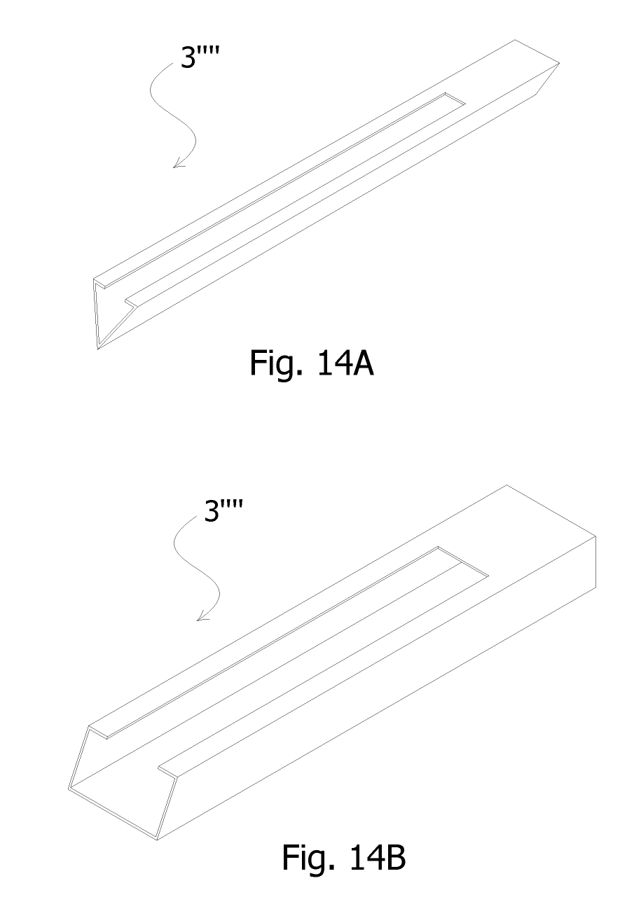

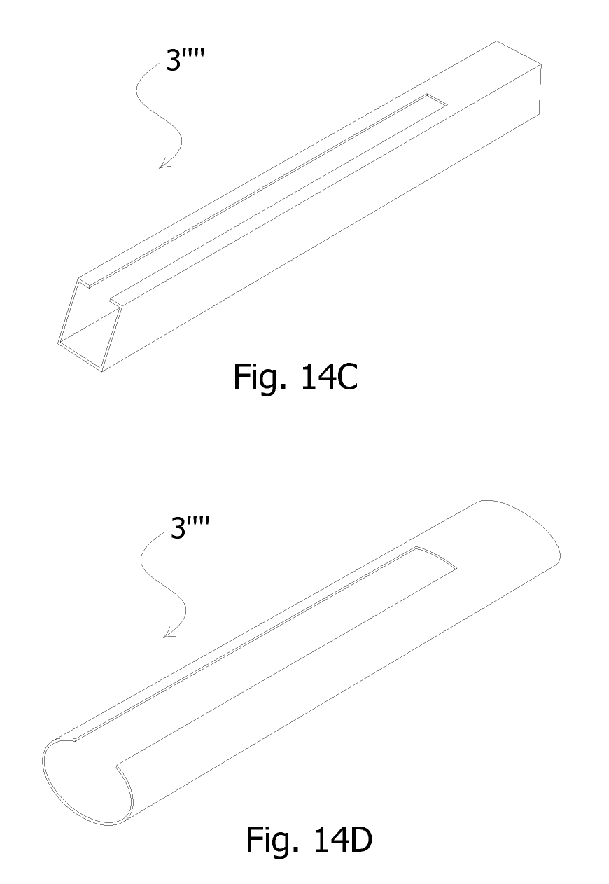

Although FIGS. 2-6 depict the tool assembly 6 being used to remove the headphone plug piece 7 from internal walls of the headphone receptacle 8 of a mobile device, this is merely one example embodiment where the tool assembly 6 is used and the tool assembly 6 can be used to remove any lodged object from internal walls of any cavity or receptacle where the object is lodged. Additionally, although feature 3 of FIG. 1A depicts a thin walled cylinder, feature 3 can be any thin walled shaped tool that matches a shape of the internal walls of the receptacle. FIGS. 14A-14D shows perspective views of one example of a tool 3″″ that can be used in place of the cylinder 3 of the tool assembly of FIG. 1A, according to one embodiment of the present invention. As depicted in FIG. 14A, in an example embodiment, the tool 3″″ is a triangular prism that is used to remove the lodged object from internal walls of a triangular cavity, in a similar manner as the cylindrical feature 3 discussed above. As depicted in FIG. 14B, in an example embodiment, the tool 3″″ is a cuboid that is used to remove the lodged object from internal walls of a rectangular cavity, in a similar manner as the cylindrical feature 3 discussed above. As depicted in FIG. 14C, in an example embodiment, the tool 3″″ is a square prism that is used to remove the lodged object from internal walls of a square cavity, in a similar manner as the cylindrical feature 3 discussed above. As depicted in FIG. 14D, in an example embodiment, the tool 3″″ is an elliptical prism that is used to remove the lodged object from internal walls of an elliptical cavity, in a similar manner as the cylindrical feature 3 discussed above.

In an example embodiment, an outer diameter of feature 3 is slightly larger than an inner diameter of the internal walls of the headphone receptacle 8, such that the feature 3 is elastically deformed by the internal walls of the headphone receptacle 8 upon insertion of the feature 3 into the headphone receptacle 8. In another example embodiment, an outer diameter of feature 3 is less than or equal to an inner diameter of the internal walls of the headphone receptacle 8, in which case external means (discussed below) are used to elastically deform the feature 3 upon insertion of the feature 3 within the headphone receptacle 8. In an example embodiment, the outer diameter of the feature 3 is adjusted such that the feature 3 can be used on a range of headphone receptacles 8 with varying inner diameters, including receptacles 8 with inner diameters less than and greater than the outer diameter of the feature 3.

In an example embodiment, an advantage of the cylinder slot 5, best shown in FIGS. 1 and 8A-8B, is that it improves the insertion of tool assembly 6 into headphone receptacles of devices of different manufacture, by allowing for internal diameter variance among the receptacles that comes as a result of different manufacturer designs, as well as manufacturing process tolerances. In another example embodiment, an advantage of feature 5 is that it improves the removal of the broken headphone plug piece by allowing cylinder 3 to be elastically deformed as it is compressed by the receptacle's 8 internal wall or external compression means, and in turn, such deformation exerts gripping pressure on the broken headphone plug piece, thus allowing for easier removal. As shown in FIGS. 1 and 8A-8B, the slot 5 extends from a first end at the angle-cut tip 4 of the cylinder 3 to a second end 29 that is located between the angle-cut tip 4 and an opposite end 31 of the cylinder 3. However, the slot 5 is not limited to this embodiment.

As shown in FIG. 1B, the cylinder 3 includes a first radius 11 which defines an inner surface 12 and hollow interior volume 13 and a second radius 15 that defines an outer diameter or external surface 17 of the cylinder 3 in an uncompressed position (i.e. prior to compression by the receptacle 8 internal walls or external compression means). As depicted in FIG. 1B, the first radius 11 is less than the second radius 15. In an example embodiment, the second radius 15 is sized such that the outer diameter 17 is slightly larger than or equal to an inner diameter of the internal walls of the receptacle 8, such that the cylinder 3 is compressed by the receptacle 8 internal walls. In another example embodiment, where the second radius 15 is sized such that the outer diameter 17 is smaller than or equal to the inner diameter of the internal walls of the receptacle 8, external compression means are used to compress the cylinder 3, as discussed below. FIG. 1C shows a cross-sectional view of the cylinder 3 of FIG. 1B in a compressed position (i.e. after compression by the receptacle 8 internal walls or external compression means). As shown in FIG. 1C, the outer surface 17 has compressed inward from the second radius 15 (FIG. 1B) to a second radius 16 that is less than the second radius 15. Additionally, the inner surface 12 has compressed inward from the first radius 11 (FIG. 1B) to a first radius 10 that is less than the first radius 11. In an example embodiment, when deformed the cylinder 3 (FIG. 1B) is compressed to a shape (FIG. 1C) that resembles an irregular lens, such as a vesical piscis shape, for example. Additionally, as shown in FIG. 1C, a width of the slot 5 of the cylinder 3 is substantially reduced when the cylinder 3 is compressed. In another example embodiment, upon compression of the cylinder 3, the first radius 10 is sized such that the interior volume 13 is sized to receive the broken headphone plug 7 when the cylinder 3 is inserted into the receptacle 8 and to frictionally engage the broken headphone plug 7 such that the broken headphone plug 7 may be removed by withdrawing the cylinder 3 from the receptacle 8. In an example embodiment, the first radius 10 is sized based on an outer diameter of the broken headphone plug 7. For example, the first radius 10 may be sized to be slightly less than equal to the outer diameter of the broken headphone plug 7, so that the broken headphone plug 7 is compressed by the cylinder 3 within the interior volume 13. In an example embodiment, the length 23 of the cylinder 3 is 37.5 millimeters (mm) or within a range of 30-45 mm, the diameter of the cylinder 3 is 3.8 mm or within a range of 3-5 mm and a thickness of the cylinder 3 is 0.3 mm or within a range of 0.2-0.4 mm. In another example embodiment, the length 25 of the cylinder slot 5 is 28.3 mm or within a range of 20-35 mm and a width of the slot 5 is 1.75 mm or within a range of 1.5-2.5 mm. In an example embodiment, the first radius 11 is 1.75 mm or within a range of 1.5-2 mm and the second radius 15 is 1.9 mm or within a range of 1.5-0.5 mm.

In one example embodiment of the invention, end cap 2 is attached to cylinder 3 by use of a strong and permanent adhesive; but it should be apparent that other assembly methods to attach end cap 2 to cylinder 3 such as welding or other mechanical means are possible. As depicted in FIG. 1A, in an example embodiment an end of the cylinder 3 opposite to the tip 4 is inserted within an open end of the end cap 2, such that an outer surface of the end of the cylinder 3 is attached to an inner surface of the open end of the end cap 2. In an example embodiment, the end cap 2 has a length of 9.5 mm or within a range of 8-11 mm and a diameter of 4.7 mm or within a range of 3.5-5.5 mm. Use of end cap 2 provides three advantages to the invention. One of those advantages is that it adds substantial structural integrity to cylinder 3, and the tool assembly in general. Another advantage is that the end cap 2 provides an attachment point for split ring 1. Another advantage is that the ring end of end cap 2, which is the end of the end cap 2 attached to the split ring 1, provides a structurally strong point in the tool assembly where the required mechanical force can be applied to properly push the tool into the headphone receptacle such that the cylinder 3 passes into the receptacle 8 and the cylinder 3 passes between the broken headphone plug piece 7 and the internal walls of the receptacle 8. However, the tool assembly 6 need not include the end cap 2. In an example embodiment, the tool assembly 6 includes the cylinder 3 without the end cap 2, where the mechanical force is applied to an end of the cylinder 3 opposite from the angle-cut tip 4. In this example embodiment, the end of the cylinder 3 opposite from the angle-cut tip 4 can provide the attachment point for split ring 1.

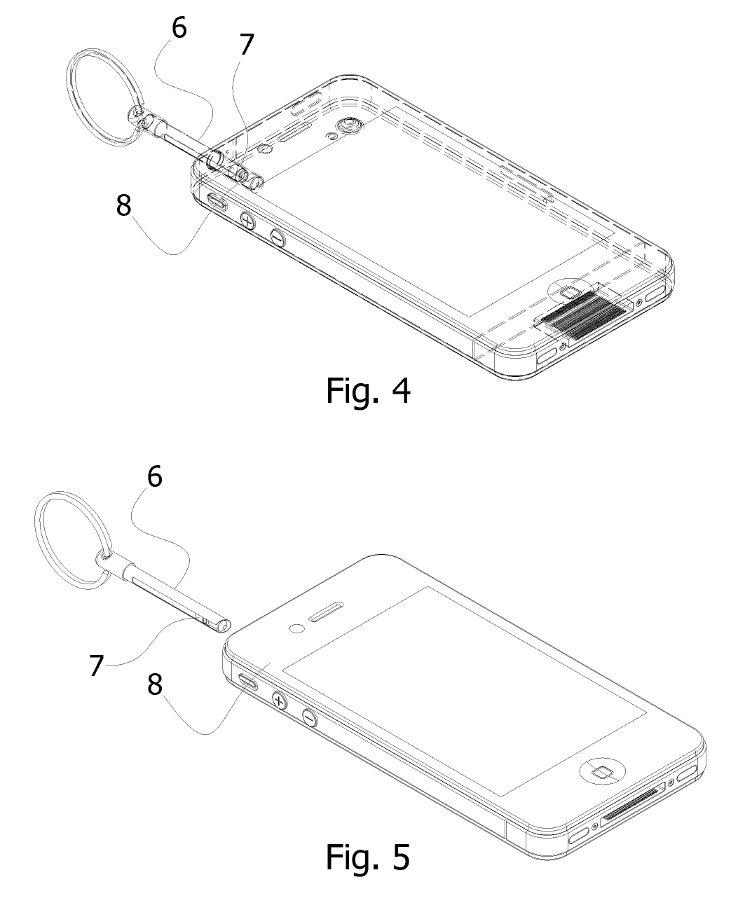

In the example embodiment of the invention shown in Figure TA, split ring 1 is attached to end cap 2 by looping the split ring around the hole at the ring end of end cap 2. In an example embodiment, the diameter of the split ring 1 is 25.25 mm or in a range of 20-30 mm and the hole in the ring end of the end cap 2 has a diameter of 2.1 mm or in a range of 1.5-0.5 mm. The use of a standard split ring part, like the ones used to hold keys, is an advantage of the example embodiment of the invention, since they are readily available at very low costs, thus reducing the manufacturing and assembly costs of producing the tool. Split rings need not be used, and other ring or handle styles can also be used in place of the split ring 1. In an example embodiment, the split ring 1 is used as a handle to pull the tool assembly 6 from the device's headphone receptacle, after it has been inserted into it. This is depicted in FIGS. 4-6, which show the tool assembly 6 and cylinder 3 pulled from the headphone receptacle 8, with the broken headphone plug piece 7 within the cylinder 3. Other advantages of the split ring 1 are that is can be used to hang the tool for storage, or to securely attach the tool to other things like, for example, a chain or keys.

In an example embodiment, the material used for cylinder 3 is rigid enough to resist being inserted between the headphone receptacle 8 internal walls and the headphone broken piece 7 without losing its shape in an example embodiment of the invention, the cylinder 3 shown in FIG. 1A, as well as end cap 2, and split ring 1 are all fabricated of a stainless steel alloy. In another example embodiment, one or more of the cylinder 3, end cap 2 and split ring 1 are fabricated from the stainless steel alloy. An advantage of the use of a stainless steel alloy is the strength of such a thin wall cylinder, and durability and corrosion resistance. However, in another example embodiment, use of other materials such as plastics for cylinder 3 is employed and has other advantages under certain circumstances.

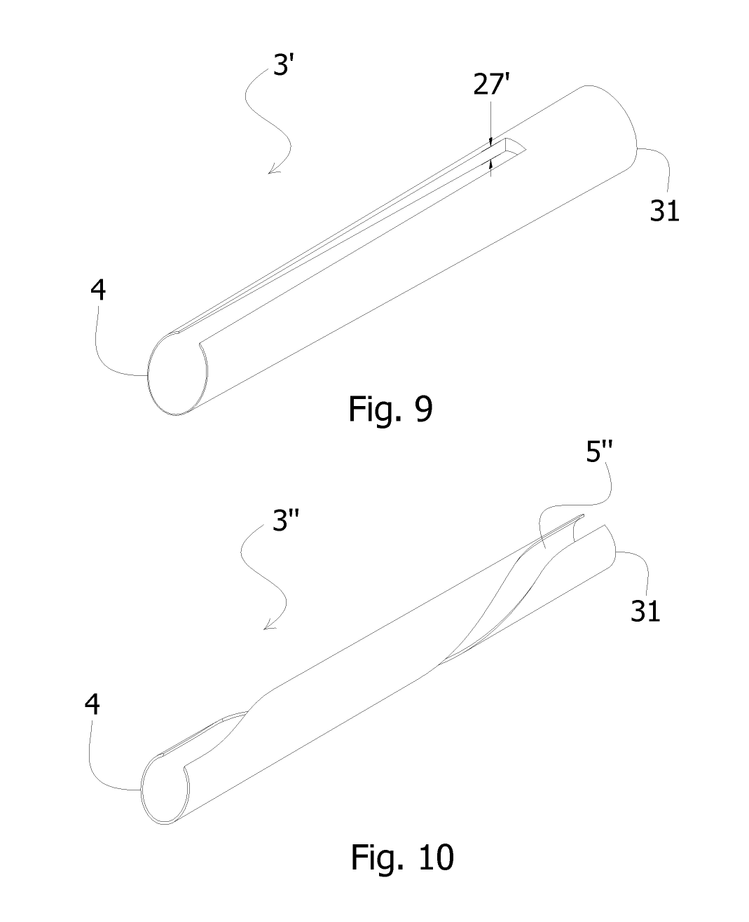

FIG. 9 shows a perspective view of one example of the cylinder 3′ of the tool assembly 6 of FIG. 1A, according to one embodiment of the present invention. A thickness 27′ of the cylinder 3′ is defined as a difference between the second radius 15 and the first radius 11 (FIG. 1B). As shown in FIG. 9, in an example embodiment of the cylinder 3′, the thickness 27′ varies along a length of the cylinder 3′. In another example embodiment, the thickness 27′ has a minimum value at the tip 4 and the thickness 27′ increases from the tip 4 in a direction of the second end 31 of the cylinder 3′. In an example embodiment, the thickness 27′ continuously increases from a minimum value at the tip 4 to a maximum value at the second end 31. In an example embodiment, the minimum thickness 27′ at the tip 4 is 0.1 mm or within a range of 0.05-0.2 mm and the maximum thickness 27′ at the second end 31 is 1.0 mm or within a range of 0.8-1.2 mm. One advantage of the variable thickness 27′ of the cylinder 3′ is that the increased thickness 27′ at the second end 31 results in a sturdy construction where force is applied during insertion and extraction from the receptacle 8. Another advantage of the variable thickness 27′ is that the minimum thickness 27′ at the tip 4 accommodates insertion of the tip 4 between the plug piece 7 and the receptacle 8 internal walls.

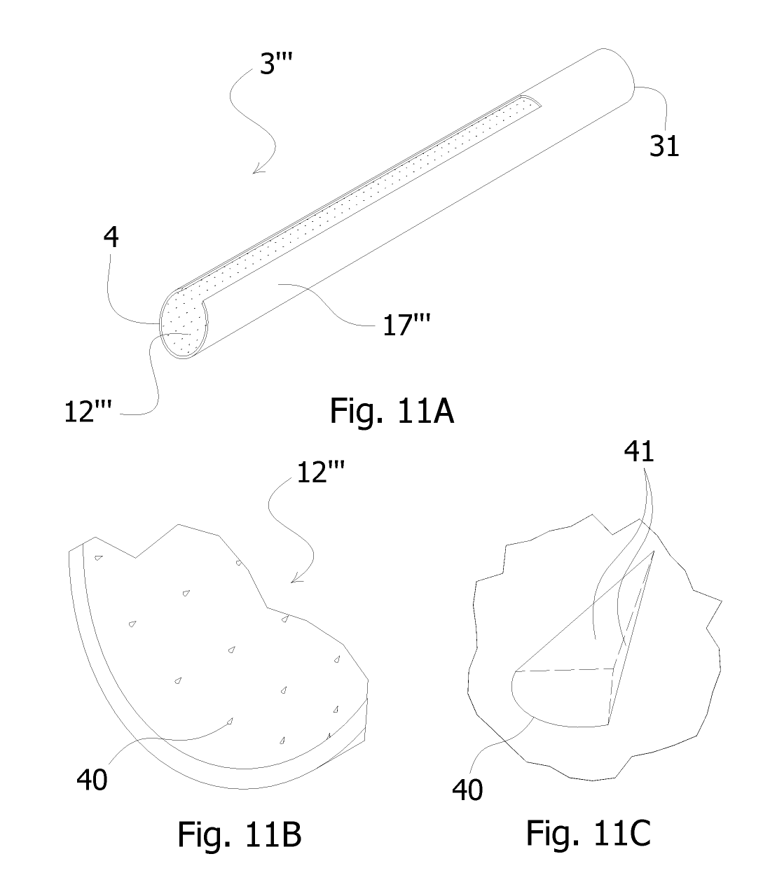

FIGS. 11A-11C shows perspective views of one example of the cylinder 3′″ of the tool assembly of FIG. 1A, according to one embodiment of the present invention. As depicted in FIGS. 11A-11C, first material 40 is applied along the inner surface 12′″ of the cylinder 3′″. The first material 40 is selected such that a frictional force between the inner surface 12′″ and the plug piece 7 is greater than a frictional force between the outer surface 17′″ and the internal walls of the receptacle 8 during insertion and/or extraction of the cylinder 3′″. Additionally, in an example embodiment, the first material 40 is selected such that the frictional force between the inner surface 12′″ and the plug piece 7 is greater during extraction of the cylinder 3′″ from the receptacle 8 than during insertion of the cylinder 3′″ into the receptacle. In an example embodiment, the outer surface 17′″ is polished to a mirror finish. In another example embodiment, the outer surface 17′″ is treated with a second material such as polytetrafluoroethylene (PTFE), i.e. Teflon®. In an example embodiment, the first material 40 is micro barb material with surfaces 41 oriented toward the second end 31 of the cylinder 3′″ such that the surfaces 41 engage the plug piece 7 during extraction of cylinder 3′″ hut do not engage the plug piece 7 during insertion of the cylinder 3″″. In an example embodiment, the micro barb material is integral with the inner surface 12′″ and/or manufactured into the inner surface 12″ using a knurling or machined texture. One advantage of the first material 40 is easy insertion of the cylinder 3′″ within the receptacle 8 based on reduced frictional force during insertion and easy extraction of the cylinder 3′″ based on the enhanced frictional force during extraction. In another example embodiment, an adhesive can be applied along the inner surface 12′″ instead of the first material 40, to enhance a frictional force between the inner surface 12′″ and the plug piece 7. In an example embodiment, the adhesive is a high viscosity non-setting adhesive. In another example embodiment, the adhesive is a friction activated adhesive.

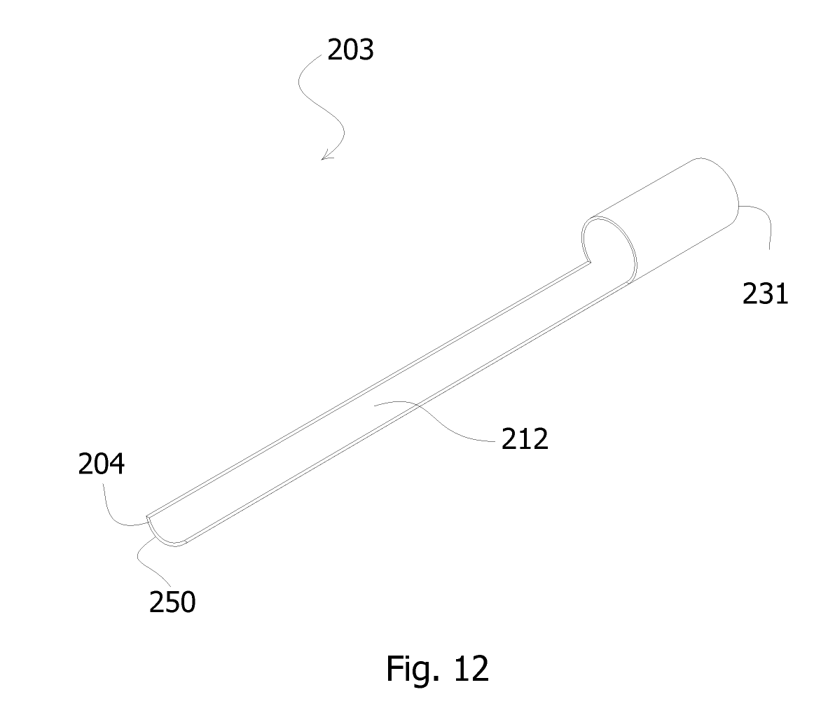

FIG. 12 shows a perspective view of one example of a tool 203 of a removal tool assembly for a headphone plug, according to one embodiment of the present invention. In an example embodiment, the tool 203 can be used in place of the cylinder 3 of the tool assembly 6 of FIG. 1A. Unlike the cylinder 3, the tool 203 includes a strip with an arc length 250 at a tip 204 that is less than a circumference of the lodged object 7 within the receptacle 8. The tool 203 extends from the tip 204 to a second end 231 opposite to the tip 204. In an example embodiment, the arc length 250 is less than one half of the circumference of the lodged object 7. In another example embodiment, the arc length 250 is less than one quarter of the circumference of the lodged object 7. The tool 203 is inserted into the receptacle 8 in a similar manner as the cylinder 3 discussed above and the tip 204 of the strip is inserted between the lodged object 7 and the receptacle 8 internal walls in a similar manner as the tip 4 of the cylinder 3 discussed above.

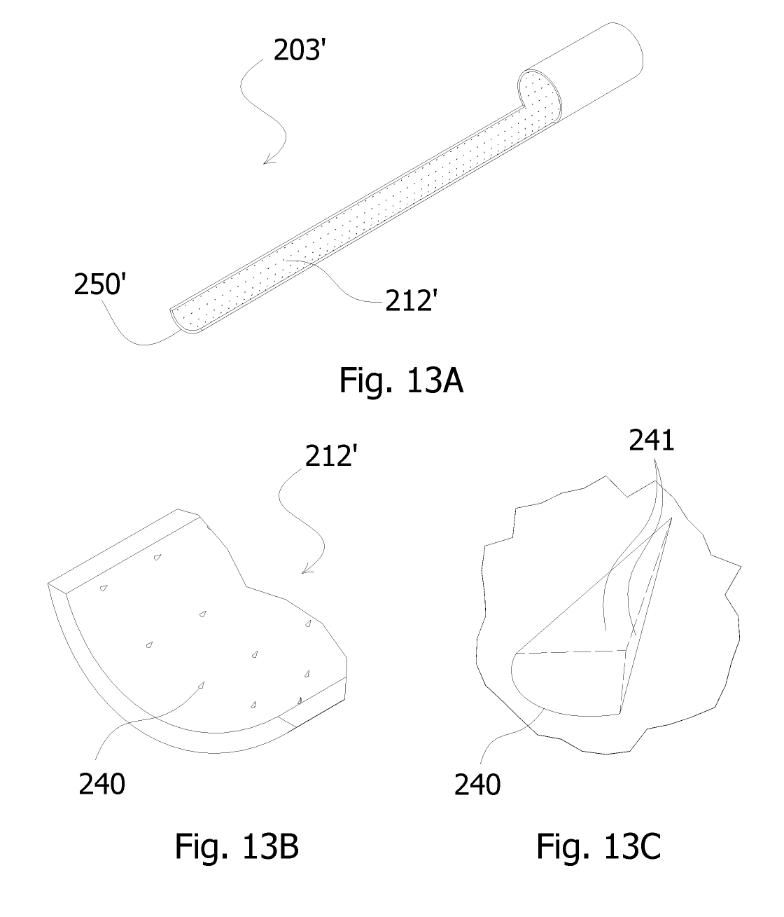

FIGS. 13A-13C shows perspective views of one example of the tool 203′ of the tool assembly of FIG. 12, according to one embodiment of the present invention. First material 240 that is similar to the first material 40 of FIGS. 11A-11C is applied along the inner surface 212′ of the tool 203′. As with the first material 40 of FIGS. 11A-11C, the first material 240 is selected such that a frictional force between the inner surface 212′ and the lodged object 7 is greater during extraction than insertion of the tool 203′ into the receptacle 8. In an example embodiment, the first material 240 is micro barb material with surfaces 241 that are structured and oriented in a similar manner as the surfaces 41 of the first material 40 of FIGS. 11A-11C.

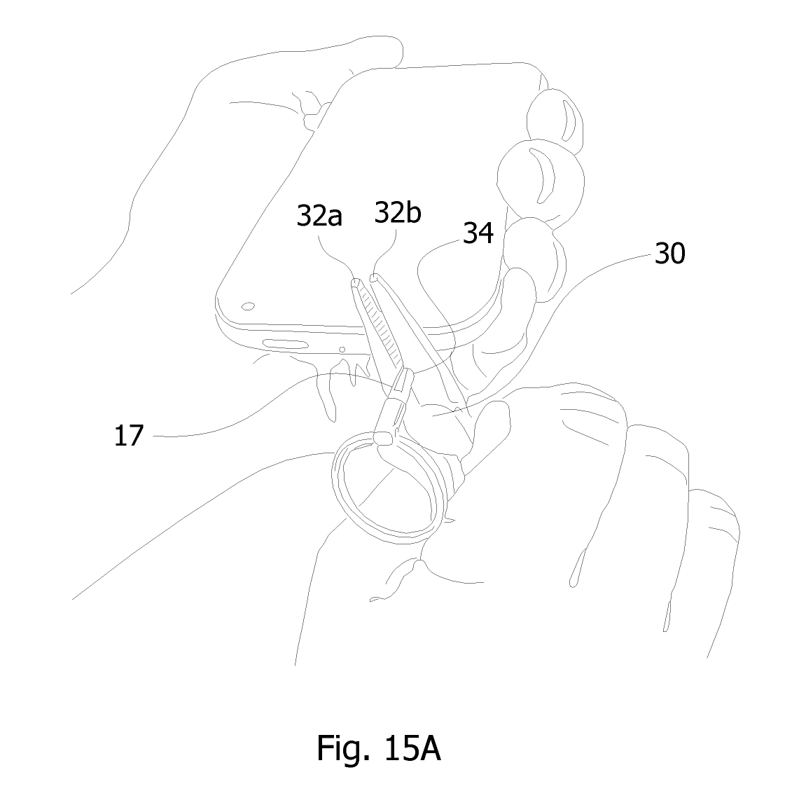

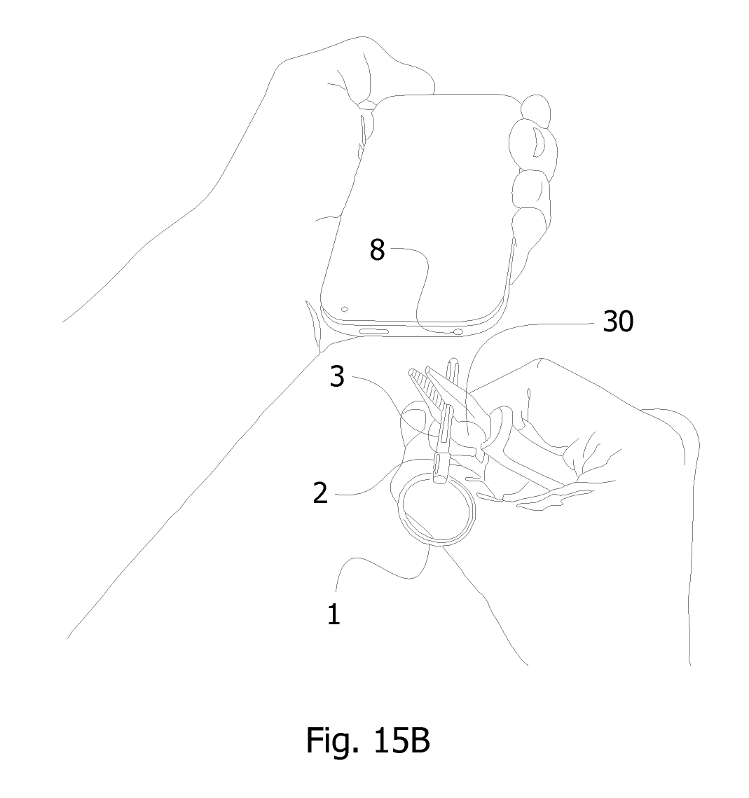

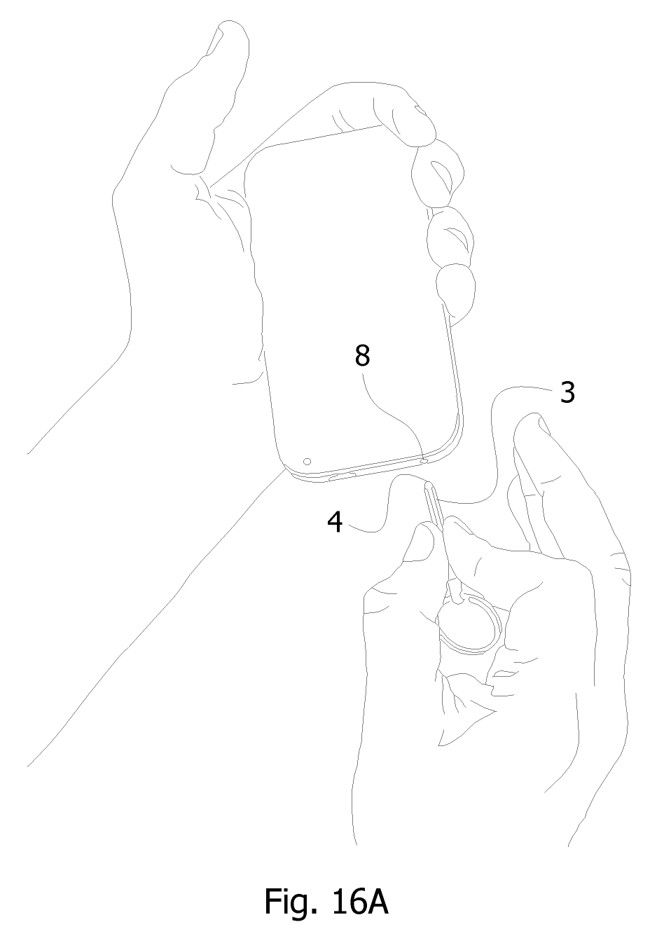

FIGS. 15A-15B shows perspective views of one example of external means for compressing the tool 3 during insertion and/or extraction from the receptacle 8. In this example embodiment, the external means are pliers 30 being used to insert and/or extract the tool 3 into/from the headphone receptacle 8, according to one embodiment of the present invention. As shown in FIG. 15A, a slot 34 is formed between jaws 32a, 32b of the pliers 30 when the jaws 32a, 32b are in a closed position. An inner diameter of the slot 34 is based on the second radius 16 of the outer surface 17 when the cylinder 3 is in the compressed position within the receptacle 8. In an example embodiment, the inner diameter of the slot 34 is equal to the second radius 16. In another example embodiment, the inner diameter of the slot 34 is 5% larger or within a range of 0-20% larger than the second radius 16. In an example embodiment, during insertion of the tool 3 within the receptacle 8, the outer surface 17 of the tool 3 is positioned within the slot 34 and the jaws 32a, 32b are moved from an open position to the closed position such that the slot 34 compresses the outer surface 17 from the second radius 15 to the second radius 16 (i.e. the compressed position of the tool 3). An advantage of the pliers 30 is that since the slot 34 inner diameter is based on the second radius 16, the jaws 32a, 32b will not over compress the outer surface 17 beyond the second radius 16. As shown in FIG. 15A, during extraction of the tool 3 from the receptacle 8, the jaws 32a, 32b are closed around the outer surface 17 such that the cylinder 3 is received within the slot 34. As shown in FIG. 15B, to extract the cylinder 3 and the piece 7 from the receptacle 8, the pliers 30 are pulled which simultaneously extracts the cylinder 3 and the headphone broken plug piece 7 from the receptacle 8. One advantage of the pliers 30 is that the slot 34 is sized to prevent damage to the cylinder 3 due to over compression of the cylinder 3.

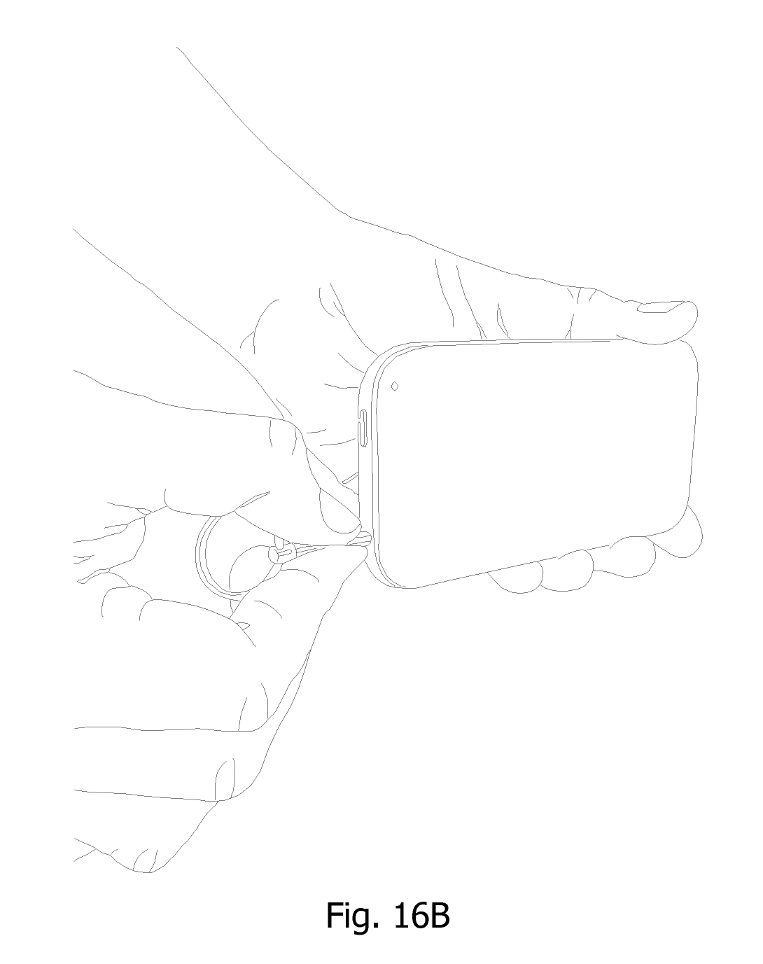

FIGS. 16A-16B shows perspective views of one example of another external means for compressing the tool 3 during insertion and/or extraction from the receptacle 8. In this example embodiment, the external means are fingers (including a thumb) being used to insert and/or extract the cylinder 3 to/from the headphone receptacle 8, according to one embodiment of the present invention. During insertion of the cylinder 3 within the receptacle 8, the fingers are used to compress the outer surface 17 from the second radius 15 to the second radius 16. As shown in FIG. 16A, the thumb and index finger are used to pinch the cylinder 3 during the insertion of the cylinder 3 within the receptacle 8. As shown in FIG. 16B, the thumb and index finger are also used to pinch the cylinder 3 during extraction of the cylinder 3 from the receptacle 8. In an example embodiment, the external means of FIGS. 15A-15B and 16A-16B are used during insertion and/or extraction of the cylinder 3 within the receptacle 8 when the second radius 15 is less than an inner diameter of the internal walls of the receptacle 8. However, the external means may still be used for insertion and/or extraction when the second radius 15 is greater than the inner diameter of the internal walls of the receptacle 8.

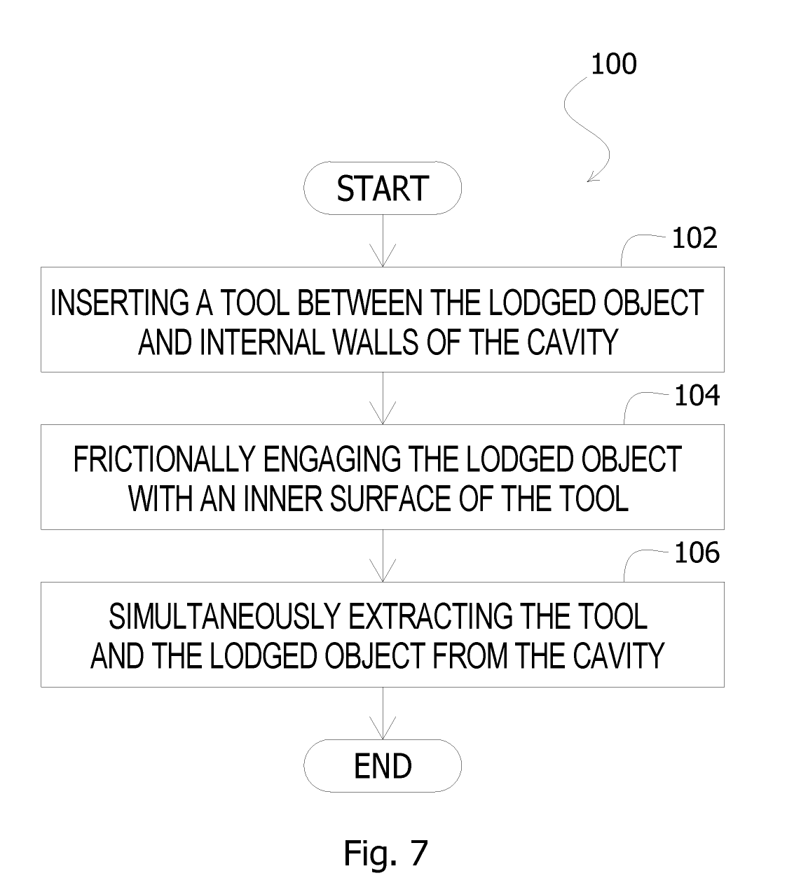

FIG. 7 depicts a flowchart of one example of a method 100 for removing the broken headphone plug piece 7 from the headphone receptacle 8 of the mobile device, according to one embodiment of the present invention. The method 100 begins by inserting 102 the tool between the lodged object and internal walls of the cavity. In an example embodiment, step 102 involves inserting the cylinder 3 between the headphone broken piece 7 and internal walls of the headphone receptacle 8 of the mobile phone such that the tip 4 is positioned between the piece 7 and the internal walls of the receptacle 8. In an example embodiment, step 102 involves compressing the outer surface 17 of the cylinder 3 from the second radius 15 to the second radius 16. In an example embodiment, the compressing the outer surface 17 is performed by internal walls of the receptacle 8, when the second radius 15 is larger than an inner diameter of the internal walls of the receptacle 8. In another example embodiment, the compressing the outer surface is performed by external means other than the internal walls of the receptacle 8, when the second radius 15 is less than an inner diameter of the internal walls of the receptacle 8. In another example embodiment, step 102 involves inserting the tool 203 between the headphone broken piece 7 and internal walls of the headphone receptacle 8, such that the tip 204 is positioned between the piece 7 and the internal walls of the receptacle 8.

The method 100 also includes frictionally engaging 104 the lodged object with an inner surface of the tool. In an example embodiment, step 104 involves frictionally engaging the headphone broken piece 7 with the inner surface 12 of the cylinder 3. In another example embodiment, step 104 involves frictionally engaging the piece 7 with surfaces 41 of the first material 40 along the inner surface 12. In an example embodiment, step 104 involves frictionally engaging the headphone broken piece 7 with the inner surface 212 of the tool 203. In another example embodiment, step 104 involves frictionally engaging the headphone broken piece 7 with surfaces 241 of the first material 240 along the inner surface 212′.

The method 100 also includes simultaneously extracting 106 the tool and the lodged object from the cavity. In an example embodiment, step 106 involves simultaneously extracting the cylinder 3 and the headphone broken piece 7 (within the hollow interior 13 of the cylinder 3) from the headphone receptacle 8 of the mobile phone. In another example embodiment, step 106 involves simultaneously extracting the tool 203 and the headphone broken piece 7 from the headphone receptacle 8. In an example embodiment, step 106 includes gripping the outer surface 17 of the cylinder 3 with a pair of jaws 32a, 32b of a pliers 30 and pulling the pliers 30 to simultaneously extract the cylinder 3 and the broken piece 7 from the receptacle 8. In an example embodiment, the gripping step includes positioning the outer surface 17 of the cylinder 3 in a slot 34 defined between the jaws 32a, 32b in a closed position, where the slot 34 has an inner diameter that is defined by the second diameter 16 (i.e. outer diameter of the outer surface 17 when the cylinder 3 is in the compressed position) to prevent the jaws 32a, 32b from damaging the cylinder 3 during step 106.

In an example embodiment, the inner surface 12 of the cylinder 3 frictionally engages the broken piece 7 during step 106 with a greater frictional force than during step 102. This is due to the surfaces 41 of the first material 40 which are oriented such that the frictional force between the inner surface 12 and the piece 7 is greater during extraction than insertion of the cylinder 3 within the receptacle 8. The inner surface 212′ of the tool 203′ is similarly arranged such that the inner surface 212′ frictionally engages the broken piece 7 during step 106 with a greater frictional force than during step 102, as a result of the surfaces 241 of the first material 240 along the inner surface 212′.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article. As used herein, unless otherwise clear from the context, a value is “about” another value if it is within a factor of two (twice or half) of the other value. While example ranges are given, unless otherwise clear from the context, any contained ranges are also intended in various embodiments. Thus, a range from 0 to 10 includes the range 1 to 4 in some embodiments.

1. A tool assembly for removing a lodged object from a cavity comprising:
a tool comprising;
a hollow interior volume defined by a first radius;
an outer surface defined by a second radius, where the second radius is greater than the first radius,
wherein the outer surface of the tool is configured to be compressed upon insertion of the tool within the cavity;
and wherein the first radius is sized such that the hollow interior volume is configured to receive the lodged object upon insertion of the tool between the lodged object and the internal walls of the cavity and to frictionally engage the lodged object such that the object may be removed by withdrawing the tool from the cavity.

2. The tool assembly according to claim 1, wherein the tool is a cylinder configured to be inserted within a cylindrical cavity and wherein the second radius is sized to be larger than an inner diameter of internal walls of the cavity such that the outer surface of the cylinder is compressed by the internal walls of the cavity.

3. The tool assembly according to claim 1, wherein the tool is one of a triangular prism configured to be inserted into a triangular cavity, a cuboid configured to be inserted into a rectangular cavity and an elliptical prism configured to be inserted into an elliptical cavity.

4. The tool assembly according to claim 1, wherein the cavity is a headphone receptacle and the lodged object is a broken headphone plug piece.

5. The tool assembly according to claim 1, wherein the tool comprises an angle-cut tip configured to enhance insertion of the tool between the lodged object and the internal walls of the cavity, wherein the angle-cut tip forms an angle with a longitudinal axis of the tool other than 90 degrees.

6. The tool assembly according to claim 1, wherein the tool comprises a tip configured to be inserted between the lodged object and the internal walls of the cavity and a second end opposite to the tip, wherein a thickness of the tool defined as a difference between the second radius and the first radius is greater at the second end than at the tip.

7. The tool assembly of claim 2, wherein the cylinder comprises a slot along at least a portion of a length of the cylinder, said slot configured to facilitate the compression of the outer surface and reduce the second radius by the internal walls of the cavity upon insertion of the cylinder within the cavity.

8. The tool assembly of claim 7, wherein the slot is oriented parallel to a longitudinal axis of the cylinder.

9. The tool assembly of claim 7, wherein the slot forms an angle in a range of 40-80 degrees with a longitudinal axis of the cylinder.

10. The tool assembly of claim 1, wherein the hollow interior volume is configured to frictionally engage the lodged object upon compression of the second radius of the outer surface to a reduced second radius, wherein the assembly further comprises pliers including jaws that form a slot with an inner diameter defined by the reduced second radius when the jaws are in a closed position, wherein the jaws are configured to grip the outer surface of the tool within the slot to compress the outer surface to the reduced second radius upon insertion of the tool within the cavity and prevent compression of the outer surface beyond the reduced second radius.

11. The tool assembly of claim 7, wherein the cylinder includes a first end to be inserted within the cavity and a second end opposite to the first end and wherein the slot extends from a first end at the first end of the cylinder to a second end located between the first end and the second end of the cylinder.

12. The tool assembly of claim 1, further comprising an adhesive on an inner surface of the tool defining the hollow interior volume, wherein the adhesive is configured to frictionally engage the lodged object along the inner surface within the hollow interior volume.

13. A method for removing a lodged object from a cavity comprising:
inserting a tool between the lodged object and internal walls of the cavity;
frictionally engaging the lodged object with an inner surface of the tool; and
simultaneously extracting the tool and the lodged object from the cavity.

14. The method of claim 13, wherein said tool is a cylinder, wherein the inserting comprises compressing an outer surface and the inner surface of the cylinder to a compressed outer surface and a compressed inner surface and wherein the frictionally engaging comprises frictionally engaging the lodged object with the compressed inner surface of the tool.

15. The method of claim 14, wherein the compressing comprises compressing the outer surface of the cylinder by the internal walls of the cavity, based on a radius of the outer surface being larger than an inner diameter of the internal walls.

16. The method of claim 14, wherein the compressing comprises externally compressing the outer surface of the cylinder with an external means other than the internal walls of the cavity.

17. The method of claim 16, wherein the compressing comprises positioning the outer surface of the cylinder in a slot in a pair of jaws of a pliers and compressing the jaws from an open position to a closed position, wherein an inner diameter of the slot in the closed position is a diameter of the compressed outer surface to prevent compression of the outer surface beyond the compressed outer surface.

18. The method of claim 17, wherein the simultaneously extracting comprises positioning the outer surface of the cylinder in the slot in the jaws of the pliers, gripping the outer surface of the cylinder with the jaws of the pliers in the closed position and pulling the pliers to simultaneously extract the tool and the lodged object from the cavity.

19. The method of claim 13, wherein the frictionally engaging comprises frictionally engaging the lodged object with the inner surface during the extracting step with a greater frictional force than during the inserting step.

20. A tool assembly for removing a lodged object from a cavity comprising:
a tool comprising;
an inner surface made of a first material, said inner surface configured to engage the lodged object with a first frictional force;
an outer surface made of a second material, said outer surface configured to engage internal walls of the cavity with a second frictional force;
wherein the first material and the second material are selected such that the first frictional force is greater than the second frictional force and such that the object is removed by withdrawing the tool from the cavity; and
wherein the tool is a strip that extends over a portion of a perimeter of the lodged object within the cavity such that the strip does not encompass the lodged object within the cavity and wherein the first material is selected such that the first frictional force during removal of the tool from the cavity is greater than during insertion of the tool within the cavity.
